(19) United States
(12) Patent Application Publication
(10) Pub. No.: US 2023/0136186 A1
(43) Pub. Date: May 4, 2023

(54) POSITION MEASUREMENT APPARATUS, POSITIONING METHOD AND PROGRAM

(71) Applicant: NIPPON TELEGRAPH AND TELEPHONE CORPORATION, Tokyo (JP)

(72) Inventor: Seiji YOSHIDA, Musashino-shi, Tokyo (JP)

(21) Appl. No.: 17/906,894

(22) PCT Filed: Apr. 28, 2020
(86) PCT No.: PCT/JP2020/018161

§ 371 Date: Sep. 21, 2022

(51) Int. Cl. G01S 5/02

(52) U.S. Cl. CPC G01S 5/0269

(57) ABSTRACT

A position measuring apparatus for positioning a mobile object includes a positioning control unit that determines a candidate area type of a position of the mobile object in accordance with an attribute of the mobile object and geospatial information, divides a candidate area corresponding to the candidate area type into a plurality of grids, specifies a grid in which the mobile object is estimated to be located from among the plurality of grids, and outputs a positioning solution of a carrier-phase based positioning calculation by an absolute position positioning unit, the positioning solution being obtained by using the grid specified.

### TECHNICAL FIELD

The present disclosure relates to a technique for measuring a position of a mobile object with high accuracy.

### BACKGROUND ART

In recent years, positioning by a navigation satellite system, such as a global navigation satellite system (GNSS), has been utilized in a wide range of applications.

Positioning methods by GNSS include a code based positioning method that can obtain positioning accuracy of about several meters and a carrier-phase based positioning method that achieves centimeter-class positioning accuracy. A method of carrier-phase based positioning used includes, for example, a real time kinematic method corresponding to a mobile object.

One of the applications using GNSS positioning is positioning of an automatic traveling vehicle. Automatic traveling requires positioning accuracy of an absolute position of sub-meters (the order of several centimeters to several tens of centimeters) capable of determining a lane on which a vehicle travels and a vehicle position in the lane. Therefore, it is assumed that a carrier-phase based positioning method is mainly applied.

### CITATION LIST

### Non Patent Literature

NPL 1: P. D. Groves, 2011. Shadow Matching: A New GNSS Positioning Technique for Urban Canyons. The Journal of Navigation, vol. 64, no. 03, pp. 417-430

### SUMMARY OF THE INVENTION

### Technical Problem

GNSS positioning not only decreases a convergence (Fix) rate of carrier-phase based positioning in a reception environment called an urban canyon, which has a structure, such as a high-rise building, around a reception position but also outputs an erroneous carrier-phase based positioning solution or deteriorates accuracy of a code based positioning solution used when a carrier-phase based positioning solution is not obtained.

The present disclosure has been made in view of the above issue, and an object thereof is to provide a technique capable of improving positioning accuracy in an urban canyon reception environment.

### Means for Solving the Problem

The disclosed technology provides a position measuring apparatus for positioning a mobile object including a positioning control unit that determines a candidate area type of a position of the mobile object in accordance with an attribute of the mobile object and geospatial information, divides a candidate area corresponding to the candidate area type into a plurality of grids, specifies a grid in which the mobile object is estimated to be located from among the plurality of grids, and outputs a positioning solution of a carrier-phase based positioning calculation by an absolute position positioning unit, the positioning solution being obtained by using the grid specified.

### Effects of the Invention

According to the disclosed technology, positioning accuracy in an urban canyon reception environment can be improved.

### BRIEF DESCRIPTION OF DRAWINGS

FIG. 1 is a functional configuration diagram of a position measuring apparatus according to an embodiment of the present disclosure.

FIG. 2 is a diagram illustrating an example of a hardware configuration of the position measuring apparatus.

FIG. 3 is a flowchart of operations of the position measuring apparatus of a first example.

FIG. 4 is a flowchart of operations of the position measuring apparatus of a second example.

FIG. 5 is a flowchart of operations of the position measuring apparatus of a third example.

FIG. 6 is a flowchart of operations of the position measuring apparatus of a fourth example.

FIG. 7 is a flowchart of operations of the position measuring apparatus of a fifth example.

FIG. 8 is a flowchart of operations of the position measuring apparatus of a sixth example.

FIG. 9 is a diagram for explaining the operation of the position measuring apparatus.

FIG. 10 is a diagram for explaining the operation of the position measuring apparatus.

FIG. 11 is a diagram for explaining the operation of the position measuring apparatus.

FIG. 12 is a diagram illustrating an example of a configuration in which the absolute position positioning unit is on the cloud.

### DESCRIPTION OF EMBODIMENTS

Hereinafter, an embodiment of the present disclosure (the present embodiment) will be described with reference to the drawings. The embodiment to be described below is an example, and an embodiment to which the present disclosure is applied is not limited to the following embodiment.

In the following embodiment, an automobile that travels on a road in an urban canyon reception environment is cited as an example of a mobile object to be positioned, but this is an example. The present disclosure is applicable to all mobile objects other than automobiles that travel on roads.

Apparatus Configuration

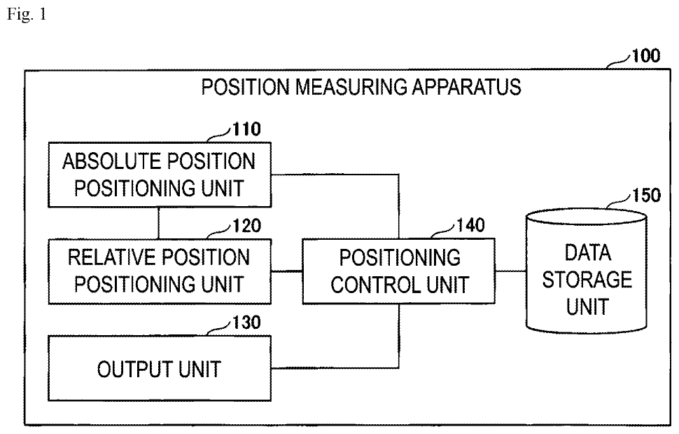

FIG. 1 illustrates a functional configuration diagram of a position measuring apparatus 100 according to the present embodiment. As illustrated in FIG. 1, the position measuring apparatus 100 according to the present embodiment includes an absolute position positioning unit 110, a relative position positioning unit 120, an output unit 130, a positioning control unit 140, and a data storage unit 150. The relative position positioning unit 120 may not include this. However, since the relative position positioning unit 120 is provided, the relative position positioning unit 120 can be used for acquiring a variation characteristic of the mobile object and selecting a grid in a candidate area, which will be described later.

The absolute position positioning unit 110 receives the GNSS satellite signal and performs code based positioning or carrier-phase based positioning. The absolute position positioning unit 110 has a function of collecting observation data and position information of the reference station, which are necessary for carrier-phase based positioning. The relative position positioning unit 120 is a vehicle speed pulse measuring instrument, an inertial measurement unit (IMU), an in-vehicle camera, a light detection and ranging (LiDAR), a GNSS Doppler shift measuring instrument, or the like. The vehicle speed pulse measuring instrument enables the speed of a vehicle, that is, a distance over which the vehicle moves per unit time to be obtained. A three-axis gyroscope and three-direction accelerometer mounted on the IMU obtains three-dimensional angular velocity and acceleration. The relative position of the vehicle can be obtained by the movement of the object in the image data captured by the in-vehicle camera. The LiDAR measures the distance to the object by irradiating the object with laser light while scanning the object and observing its scattering or reflected light, enabling the relative position of the vehicle to be calculated. In the GNSS Doppler shift, the relative displacement of the position of the mobile object can be obtained by measuring the frequency change of the carrier wave to measure the speed and temporally integrating the speed.

The relative position positioning unit 120 may be a plurality of positioning means among positioning means such as a vehicle speed pulse measuring instrument, an IMU, an in-vehicle camera, a LiDAR, and a GNSS Doppler shift measuring instrument, or may be one positioning means. In a case where the relative position positioning unit 120 includes a plurality of positioning means, a mechanism for selecting and outputting the most accurate positioning result among the positioning results obtained by each of the plurality of positioning means may be provided, or a mechanism for coupling all or some of the positioning results obtained by each positioning means with a Kalman filter or the like and outputting the results may be provided.

Furthermore, the relative position positioning unit 120 is supplied with a high-precision clock signal obtained by time synchronization with the GNSS satellite signal from the absolute position positioning unit 110. In a case where the high-precision clock signal is interrupted, the relative position positioning unit 120 is capable of maintaining the accuracy of the clock signal by the hold over (self-running operation by the oscillator) regardless of the time synchronization with the GNSS satellite signal.

The positioning control unit 140 executes processing of a procedure to be described later. The data storage unit 150 stores geospatial information, a parameter used for positioning, attribute information of a mobile object, and the like. The positioning control unit 140 may access a server that provides the geospatial information and acquire the geospatial information from the server.

The output unit 130 outputs the current position of the mobile object, which is the positioning solution output from the positioning control unit 140, to the outside of the apparatus. The current position is represented by three-dimensional coordinates of (x, y, z), but the output information may be three-dimensional coordinates themselves in a geographic coordinate system or a projection coordinate system, or may be other information. For example, a control signal may be output to a control unit of an automatic traveling vehicle, or image information indicating a position on a map may be output.

The position measuring apparatus 100 may be one physically integrated device, or may be a device in which some functional units are physically separated and a plurality of separated functional units are connected by a network. For example, the position measuring apparatus 100 may include only the positioning control unit 140, and other functional units may be provided outside the position measuring apparatus 100.

In addition, the entire position measuring apparatus 100 may be mounted on a mobile object and used, or some functions may be provided on a network (for example, on a cloud) and the remaining functions may be mounted on a mobile object and used. For example, the positioning control unit 140 may be provided on a cloud, and the remaining functions may be mounted on a mobile object and used.

In addition, for example, observation data (also referred to as Raw data) may be output from a GNSS carrier phase positioning receiver provided in a mobile object, and the observation data may be transmitted to a carrier-phase based positioning calculation processing function unit provided on a cloud to perform the carrier-phase based positioning calculation on the cloud. In this case, a positioning calculation result is returned from the carrier-phase based positioning calculation processing function unit on the cloud to the positioning control unit 140.

### Hardware Configuration Example

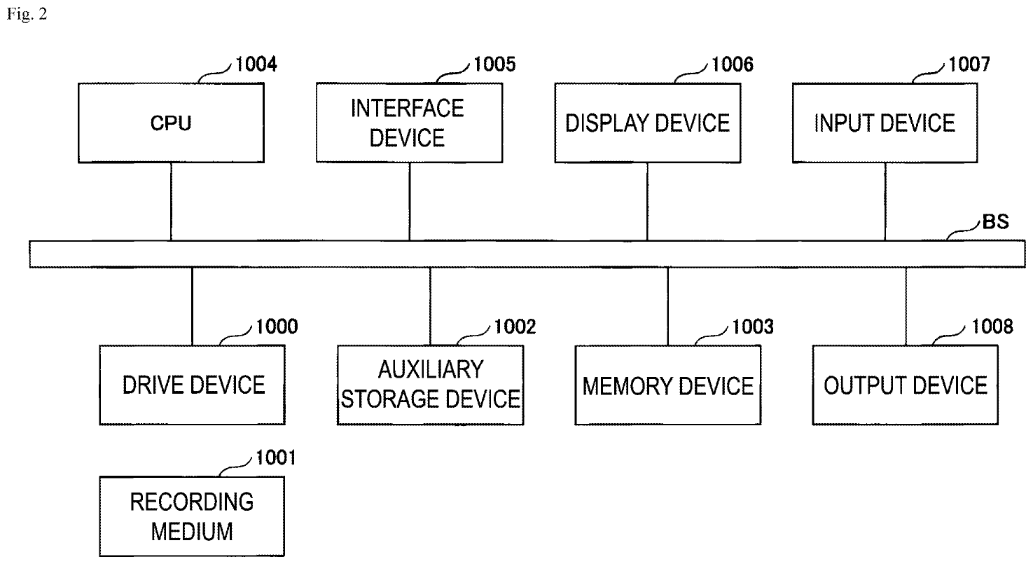

FIG. 2 is a diagram illustrating a hardware configuration example of a computer that can be used as the position measuring apparatus 100 or the positioning control unit 140 in the position measuring apparatus 100 according to the present embodiment. The computer of FIG. 2 includes a drive device 1000, an auxiliary storage device 1002, a memory device 1003, a CPU 1004, an interface device 1005, a display device 1006, an input device 1007, an output device 1008, and the like which are mutually connected by a bus B.

A program for implementing processing in the computer is provided by means of a recording medium 1001 such as a CD-ROM or a memory card. When the recording medium 1001 having a program stored therein is set in the drive device 1000, the program is installed from the recording medium 1001 through the drive device 1000 to the auxiliary storage device 1002. However, the program does not necessarily have to be installed from the recording medium 1001, and may be downloaded from another computer through a network. The auxiliary storage device 1002 stores the installed program, and stores necessary files, data, and the like.

In response to an activation instruction of the program, the memory device 1003 reads out the program from the auxiliary storage device 1002 and stores the program. The CPU 1004 implements functions related to the position measuring apparatus 100, the positioning control unit 140, or the like in accordance with a program stored in the memory device 1003. The interface device 1005 is used as an interface for connection to a network. The display device 1006 displays a graphical user interface (GUI) or the like based on the program. The input device 1007 includes a keyboard, a mouse, a button, a touch panel, or the like, and is used for inputting various operation instructions. The output device 1008 outputs the calculation result.

First to sixth examples will be described below as an operation example of the position measuring apparatus 100 having the above configuration. In the first to sixth examples, the operation example of the position measuring apparatus 100 in a case where the position measuring apparatus 100 is mounted on a mobile object (for example, an automobile) will be described.

### First Example

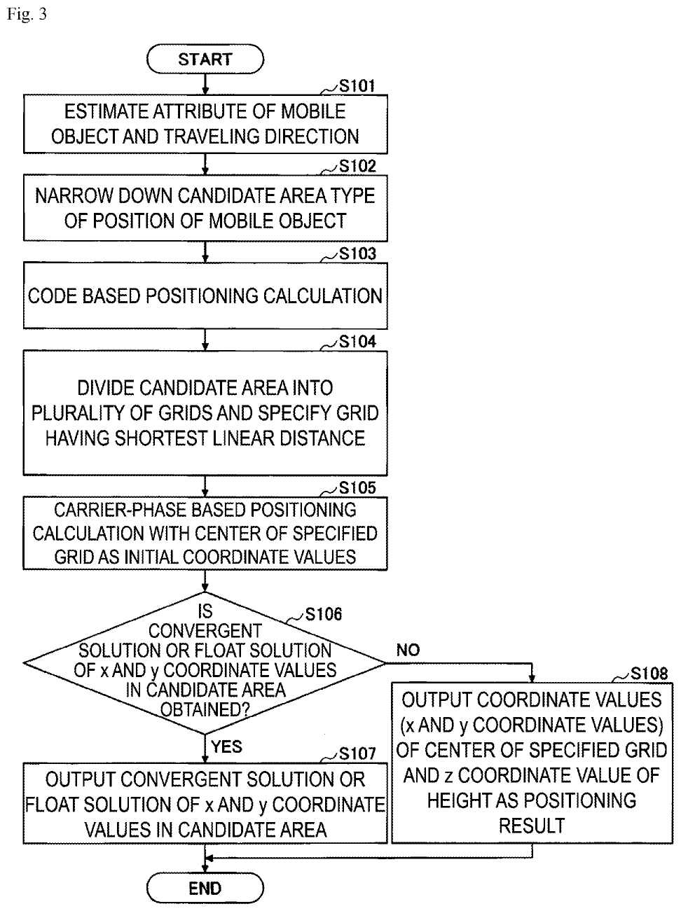

The first example will be described according to the procedure of the flowchart of FIG. 3.

S101

The positioning control unit 140 acquires a positioning result (position information of the mobile object) of the mobile object from the absolute position positioning unit 110 and a measurement result of an azimuth, an inclination, and a displacement of a position of an object from the relative position positioning unit 120 at a constant cycle, for example.

In S101, the positioning control unit 140 estimates the attribute of the mobile object (type of pedestrian, automobile/motorcycle, bicycle, railway, or the like) and the traveling direction of the mobile object from the variation characteristic (moving speed, acceleration, and the like) of the position (positioning result) of the mobile object over time obtained from the information acquired from the absolute position positioning unit 110 and the relative position positioning unit 120. For example, when detecting that the mobile object moves in a certain direction at a speed of about 60 km/h, the positioning control unit 140 can estimate that the mobile object is an automobile, a motorcycle, or a railway.

In a mode (car navigation system or the like) in which the position measuring apparatus 100 is mounted on a mobile object, information on an attribute of the mobile object (an automobile or the like) may be set in the position measuring apparatus 100 in advance by manual operation. Furthermore, for example, in a case where the position measuring apparatus 100 is a smartphone terminal or the like held by a pedestrian, “pedestrian” may be set in advance as the attribute of the mobile object by manual operation, or the setting may be changed according to the situation such as “automobile” when getting on a bus or “railway” when getting on a railway. The set information is stored in the data storage unit 150.

S102

In S102, the positioning control unit 140 narrows down the “candidate area type” of the position of the mobile object based on the attribute and the traveling direction of the mobile object specified in S101, and the geospatial information (map data or the like) acquired from the data storage unit 150 (or a server on the Internet). The candidate area type is, for example, “sidewalk”, “roadway”, “lane”, “railway track”, “track of rail-guided railway”, “bicycle dedicated road”, “crosswalk”, or the like.

The geospatial information is geospatial information including height information (altitudes, sea level elevation or the like). In the first example, it is assumed that the geospatial information is, for example, a dynamic map obtained by combining dynamic information that changes from moment to moment, such as traffic regulation/construction information/accident/traffic congestion/signal information, and static information of high-precision three-dimensional positional information (two-dimensional map information, road surface information, lane information, three-dimensional structure information, and the like).

For example, when the positioning result by code based positioning is a position on a sidewalk and if the attribute of the mobile object is an automobile, the positioning control unit 140 can regard the candidate area type of the position of the mobile object as a “lane” on the road, further narrowing down the lane of which direction from the traveling direction of the mobile object. Furthermore, if the attribute of the mobile object is “pedestrian”, based on the positioning result, “sidewalk”, “crosswalk”, and the like are narrowed down as the candidate area type. For example, in a case where the attribute of the mobile object is estimated to be an automobile, a motorcycle, or a railway based on the mobile object moving in a constant direction at a speed of about 60 km/h, when the temporal movement characteristic is along the railway track, and there is no temporary stop or deceleration due to a signal, a traffic jam, or the like, and there is no automobile dedicated road in parallel, the candidate area type can be narrowed down to “railway track” in the traveling direction.

S103

In S103, the absolute position positioning unit 110 performs a code based positioning calculation.

S104

In S104, the positioning control unit 140 first specifies a “candidate area” based on the candidate area type determined in S102, the result of the code based positioning calculation in S103, and the geospatial information, and divides the candidate area into a plurality of grids. In the present specification, “grid” is used to mean a region of one grid. The grid may be a square, a rectangle, a rhombus, or an irregular shape.

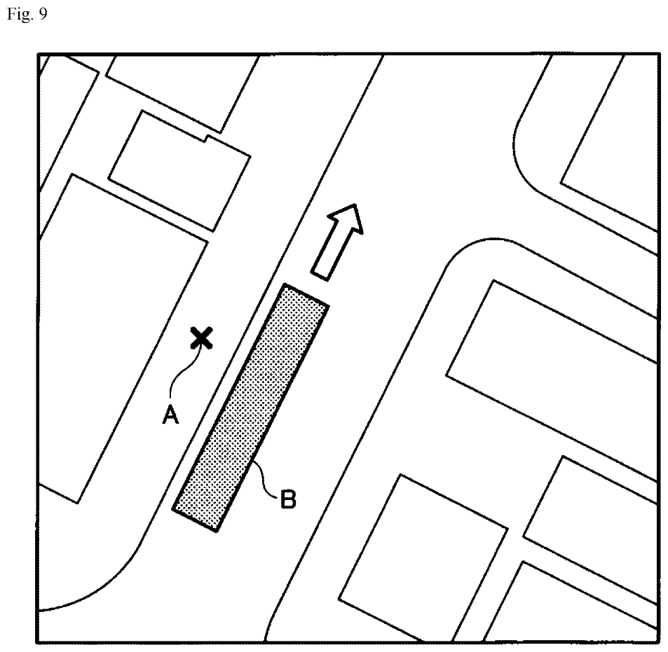

The candidate area is an area corresponding to the candidate area type near (for example, closest to) the position resulting from the code based positioning calculation. For example, when the result of the code based positioning calculation by the absolute position positioning unit 110 is a position on the sidewalk indicated by “A” and the candidate area type is “lane” in the example illustrated in FIG. 9, the positioning control unit 140 specifies a lane on the left side of the median in the traveling direction of the mobile object (“B” in FIG. 9) on the roadway closest to “A” as an area of the candidate area type closest to the position resulting from the code based positioning calculation.

Additional information may be used to determine an area corresponding to a candidate area type. For example, in a case where the area including the mobile object and the traveling direction according to the attribute of the mobile object can be specified by the day of the week, the time, and the like, the area corresponding to the candidate area type can be determined using the specified information. For example, traffic restrictions due to time or the like, an area of a pedestrian zone, an area where an event is held, and the like correspond thereto.

The width of the candidate area B illustrated in FIG. 9 in the direction perpendicular to the road can be determined, for example, to be half the road width. Furthermore, the length of the candidate area B in the direction parallel to the road can be determined based on, for example, the speed of the mobile object or the reception environment. As an example of a length determination method based on the reception environment, the length is set to be longer in a deep urban canyon environment with a low open space ratio, and to be shorter in a light urban canyon environment with a relatively high open space ratio.

Furthermore, for example, the length may be set in consideration of the operation plan for a mobile object such as a public transportation vehicle that operates according to a predetermined schedule and route.

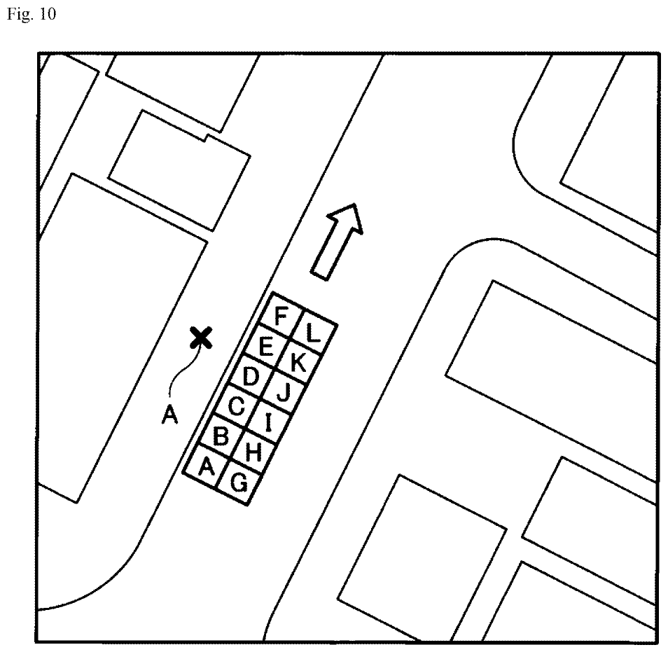

FIG. 10 illustrates an example of candidate areas divided into a plurality of grids (A to L). The size of the grid is freely selectable. The size of the grid may be, for example, a predetermined size or may be determined based on the size of the candidate area (lane width or the like). For example, when a candidate area is provided on one lane, a grid having a size of 2 m square may be used.

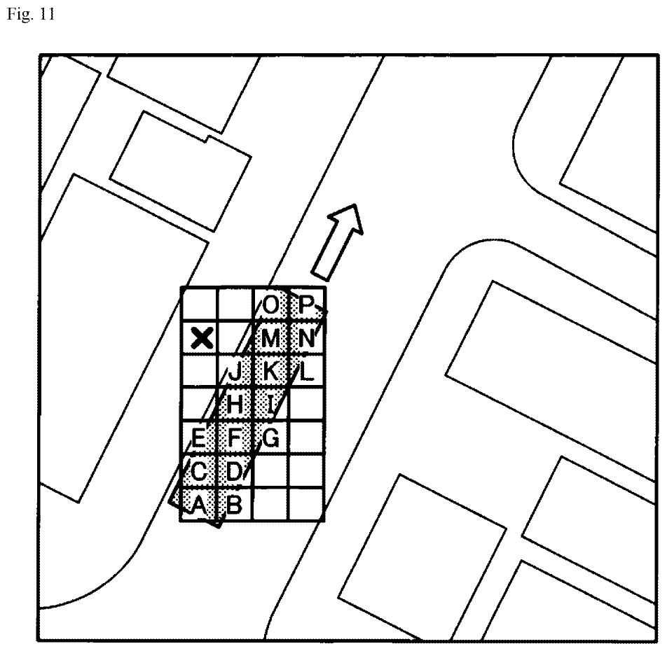

FIG. 10 illustrates an example in which each grid is generated along a roadway (one lane), but generating the grid in this manner is merely an example. For example, as illustrated in FIG. 11, grids may be generated so as to form grids along the directions of latitude and longitude.

The positioning control unit 140 specifies a grid having the closest (that is, the linear distance is the shortest) position between the same position of each grid (here, for example, the center position of the grid) and a position that is a result of the code based positioning calculation. Unless otherwise specified, the center position of the grid is a position represented by three-dimensional coordinate values (x, y, z).

With respect to the center position of the grid, x and y coordinate values of a horizontal plane (two dimensions) can be obtained from information of a two-dimensional map in geospatial information. Furthermore, as the height (z coordinate value) of the center position of the grid, a value of the height of the ground surface (for example, in the case of a road, a road surface) of the center position of the grid in the geospatial information, or a value obtained by adding the height of the reception position of the mobile object from the road surface to the value can be used.

For example, in the example illustrated in FIG. 10, assuming that the position as a result of the code based positioning calculation is A and the grid having the center closest to A is D, the positioning control unit 140 specifies the grid D as the grid having the shortest linear distance.

Specifying the grid having the shortest linear distance from the position that is the result of the code based positioning calculation as described above is an example of a method of specifying one grid in which the mobile object is estimated to be located in the candidate area. One grid in which the mobile object is estimated to be located in the candidate area is referred to as a “specified grid”.

S105

In S105, the positioning control unit 140 instructs the absolute position positioning unit 110 to perform a carrier-phase based positioning calculation with the center position of the specified grid as an initial coordinate value, and the absolute position positioning unit 110 performs carrier-phase based positioning calculation using the initial coordinate value.

S106

In S106, the positioning control unit 140 determines whether a convergence (Fix) solution is obtained in the carrier-phase based positioning calculation using the center position of the specified grid as the initial coordinate value by the absolute position positioning unit 110, or whether a float solution of x and y coordinate values in the candidate area is obtained in the carrier-phase based positioning calculation.

Obtaining the float solution of the x and y coordinate values in the candidate area means that the carrier-phase based positioning calculation does not obtain the convergence (Fix) solution but obtains the float solution, and a two-dimensional position indicated by (x, y) in three-dimensional coordinate values (x, y, z), which is the solution (position), is in the two-dimensional region of the candidate area.

When the determination result in S106 is Yes, the process proceeds to S107, and when the determination result in S106 is No, the process proceeds to S108.

S107: Case where determination result of S106 is Yes

The positioning control unit 140 transmits the convergence (Fix) solution or the float solution obtained by the absolute position positioning unit 110 to the output unit 130, and the output unit 130 outputs the convergence (Fix) solution or the float solution.

S108: Case where determination result of S106 is No

The positioning control unit 140 transmits the x and y coordinate values of the center position of the specified grid and the z coordinate value that is height information (the height of the road surface, the value obtained by adding the height of the reception position of the mobile object to the height of the road surface, and the like) of the center position of the specified grid obtained from the geospatial information to the output unit 130 as a positioning result, and the output unit 130 outputs the positioning result.

In the first example, when the convergence (Fix) solution is not obtained in the carrier-phase based positioning calculation and the float solution of the x and y coordinate values in the candidate area is obtained, the float solution is output. However, when the convergence (Fix) solution is not obtained in the carrier-phase based positioning calculation and the float solution of the x and y coordinate values in the specified grid is obtained, the float solution may be output.

### Second Example

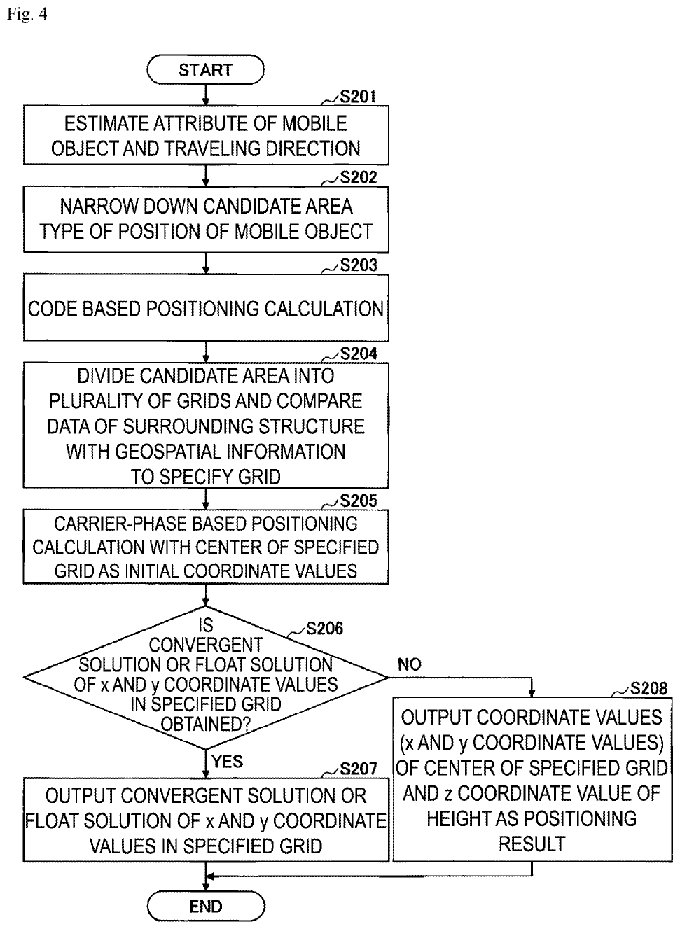

Hereinafter, a second example will be described with reference to a flowchart of FIG. 4. In the second example, differences from the first example will be mainly described.

S201 to S203

The processes of S201, S202, and S203 in FIG. 4 are the same as the processes of S101, S102, and S103 described in the first example, respectively.

S204

In S204, first, the positioning control unit 140 specifies the candidate area and divides the candidate area into a plurality of grids in the same manner as the process in S104 of the first example. In the second example, the following method is used as a method of specifying one grid in which the mobile object is estimated to be located in the candidate area.

The positioning control unit 140 compares data of a structure around the mobile object collected by the relative position positioning unit 120 (examples: in-vehicle camera, omnidirectional camera, LiDAR) with the geospatial information to specify a grid in which the mobile object is estimated to be located. The data of the structure around the mobile object can be acquired from an image by an in-vehicle camera, a sky image by an omnidirectional camera, point cloud data acquired by LiDAR, or the like.

For example, in a case where the positioning control unit 140 detects that there is a specific building right on the left in the traveling direction of the mobile object (automobile), the grid closest to the building can be specified as the grid in which the mobile object is estimated to be located.

As another method of specifying the grid in which the mobile object is estimated to be located by comparing with the geospatial information, for example, when the mobile object moves from an exit of such as a building or a concourse of a subway to the outdoors, information of an ID (identifier) of the exit is acquired by means of indoor positioning or the like, whereby the grid closest to the exit position can be specified from the geospatial information.

S205

In S205, the positioning control unit 140 instructs the absolute position positioning unit 110 to perform a carrier-phase based positioning calculation with the center position of the specified grid as an initial coordinate value, and the absolute position positioning unit 110 performs a carrier-phase based positioning calculation using the initial coordinate value.

S206

In S206, the positioning control unit 140 determines whether a convergence (Fix) solution is obtained in the carrier-phase based positioning calculation using the center position of the specified grid as the initial coordinate value by the absolute position positioning unit 110, or whether a float solution of x and y coordinate values in the specified grid is obtained in the carrier-phase based positioning calculation.

The fact that the float solution of the x and y coordinate values in the specified grid is obtained means that the convergence (Fix) solution is not obtained by the carrier-phase based positioning calculation, but the float solution is obtained, and the two-dimensional position indicated by (x, y) in the three-dimensional coordinate values (x, y, z), which is the solution (position), is in the two-dimensional region of the specified grid.

When the determination result in S206 is Yes, the process proceeds to S207, and when the determination result in S206 is No, the process proceeds to S208.

S207: Case where determination result of S206 is Yes

The positioning control unit 140 transmits the convergence (Fix) solution or the float solution obtained by the absolute position positioning unit 110 to the output unit 130, and the output unit 130 outputs the convergence (Fix) solution or the float solution.

S208: Case where determination result of S206 is No

The positioning control unit 140 transmits the x and y coordinate values of the center position of the specified grid and the z coordinate value that is height information (the height of the road surface, the value obtained by adding the height of the reception position of the mobile object to the height of the road surface, and the like) of the center position of the specified grid obtained from the geospatial information to the output unit 130 as a positioning result, and the output unit 130 outputs the positioning result.

### Third Example

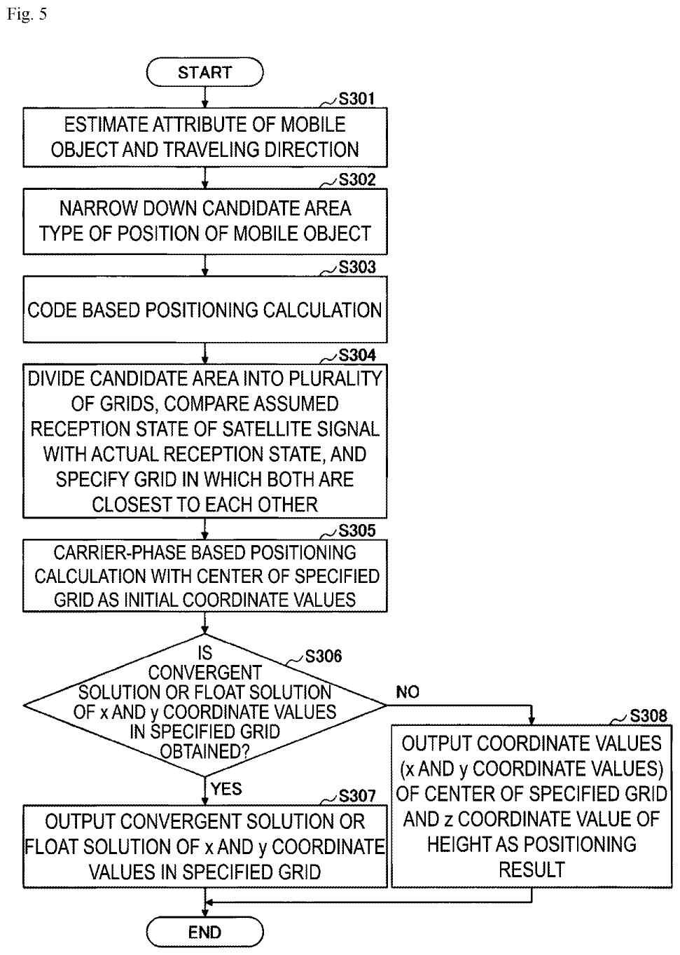

Hereinafter, a third example will be described with reference to a flowchart of FIG. 5. In the third example, differences from the first example will be mainly described.

S301 to S303

The processes of S301, S302, and S303 in FIG. 5 are the same as the processes of S101, S102, and S103 described in the first example, respectively.

S304

In S304, first, the positioning control unit 140 specifies the candidate area and divides the candidate area into a plurality of grids in the same manner as the process in S104 of the first example. In the third example, the following method is used as a method of specifying one grid in which the mobile object is estimated to be located in the candidate area.

The positioning control unit 140 compares the estimated reception state (visible/invisible state) of the GNSS satellite signal with the reception state (actual measurement value) of the GNSS satellite signal in the mobile object at the same position of each grid (here, for example, the center position of the grid), and specifies a grid in which both are closest to each other. This method is based on a method called shadow matching disclosed in NPL 1.

The positioning control unit 140 acquires orbit information of all GNSS satellites from the data storage unit 150 (or from a secure user plane location (SUPL) server of a mobile network or a server on the Internet), and acquires geospatial information (the above-described dynamic map and the like) from the data storage unit 150 (or from a server on the Internet). The positioning control unit 140 calculates the current position of each GNSS satellite based on these pieces of information, and determines, for each of grids, whether or not the GNSS satellite signal transmitted from the GNSS satellite at the current position directly reaches the center position of the grid without being blocked or reflected by a building or the like included in the geospatial information by calculation (three-dimensional ray trace simulation). The GNSS satellite signal directly reaching the grid means that the GNSS satellite is at a position (visible) that can be directly seen (in a line-of-sight state) from the center position of the grid. The GNSS satellite signal directly reaching the center position of the grid is referred to as a visible satellite signal.

Furthermore, the absolute position positioning unit 110 measures reception quality (for example, a carrier-to-noise ratio (CNR)) of each received GNSS satellite signal, and passes the measured reception quality of each GNSS satellite signal to the positioning control unit 140.

The positioning control unit 140 estimates that the GNSS satellite signal whose reception quality is equal to or higher than a predetermined threshold is the GNSS satellite signal directly (without being blocked/reflected by a building or the like) received by the mobile object from the GNSS satellite at the current position of the mobile object, that is, the visible satellite signal.

In practice, signals from a large number (for example, about 50) of GNSS satellites may be received, but here, for the sake of simplicity, it is assumed that there are five GNSS satellites 1, 2, 3, 4, and 5.

For example, it is assumed that a reception state of a visible satellite signal obtained by calculation from orbit information and geospatial information of a GNSS satellite at a center position of a certain grid (referred to as a grid A) is (GNSS satellite 1, GNSS satellite 2, GNSS satellite 3, GNSS satellite 4, GNSS satellite 5)=(1,0,1,0,0). Here, “1” means that the signal directly reaches the center position of the grid as a visible satellite signal from the GNSS satellite, and “0” means that it is not the case (that the signal is blocked and reflected by a building).

In addition, based on the reception state of the satellite signal by the absolute position positioning unit 110, it is assumed that the reception state of the visible satellite signal at the current position of the mobile object obtained by the threshold determination of the reception quality in the positioning control unit 140 is (GNSS satellite 1, GNSS satellite 2, GNSS satellite 3, GNSS satellite 4, GNSS satellite 5)=(1, 0, 1, 0, 0).

In the case of the above example, since the reception state of the theoretical value matches the reception state based on the observation, the positioning control unit 140 can estimate that the position of the mobile object is on the grid A.

The positioning control unit 140 estimates the reception state of the satellite signal by calculation in each of the grids as described above, and compares the reception state with the reception state based on actual measurement to specify a grid in which both are closest to each other. For example, in a case where 0 and 1 are used as the reception state of the visible satellite signal as described above, a grid in which the number of matching GNSS satellites of 0/1 of the reception state based on actual measurement and 0/1 of the reception state obtained by calculation is the largest is specified as a “grid in which both are closest to each other”. The grid specified in this manner is a specified grid in which the mobile object is estimated to be located in the candidate area. In the above comparison method, as the number of satellites used increases, the grid specification accuracy is improved.

S305

In S305, the positioning control unit 140 instructs the absolute position positioning unit 110 to perform a carrier-phase based positioning calculation with the center position of the specified grid as an initial coordinate value, and the absolute position positioning unit 110 performs a carrier-phase based positioning calculation using the initial coordinate value.

S306

In S306, the positioning control unit 140 determines whether a convergence (Fix) solution is obtained in the carrier-phase based positioning calculation using the center position of the specified grid as the initial coordinate value by the absolute position positioning unit 110, or whether a float solution of x and y coordinate values in the specified grid is obtained in the carrier-phase based positioning calculation.

The fact that the float solution of the x and y coordinate values in the specified grid is obtained means that the convergence (Fix) solution is not obtained by the carrier-phase based positioning calculation, but the float solution is obtained, and the two-dimensional position indicated by (x, y) in the three-dimensional coordinate values (x, y, z), which is the solution (position), is in the two-dimensional region of the specified grid.

When the determination result in S306 is Yes, the process proceeds to S307, and when the determination result in S306 is No, the process proceeds to S308.

S307: Case where determination result of S306 is Yes

The positioning control unit 140 transmits the convergence (Fix) solution or the float solution obtained by the absolute position positioning unit 110 to the output unit 130, and the output unit 130 outputs the convergence (Fix) solution or the float solution.

S308: Case where determination result of S306 is No

The positioning control unit 140 transmits the x and y coordinate values of the center position of the specified grid and the z coordinate value that is height information (the height of the road surface, the value obtained by adding the height of the reception position of the mobile object to the height of the road surface, and the like) of the center position of the specified grid obtained from the geospatial information to the output unit 130 as a positioning result, and the output unit 130 outputs the positioning result.

### Fourth Example

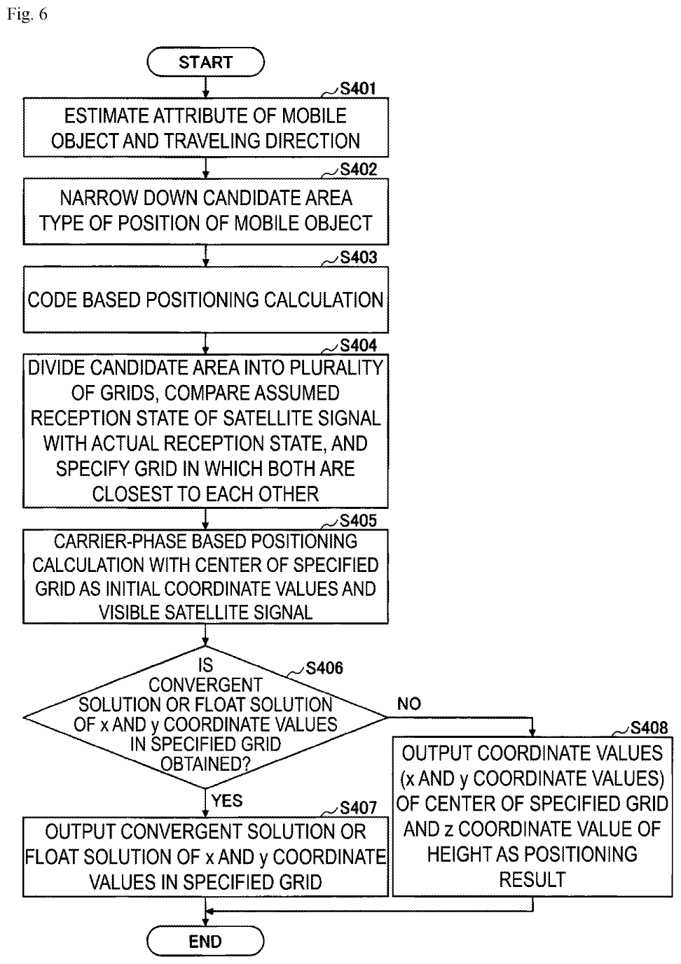

Next, a fourth example will be described with reference to a flowchart of FIG. 6. In the fourth example, differences from the third example will be mainly described.

S401 to S404

The processes of S401, S402, S403, and S404 in FIG. 6 are the same as the processes of S301, S302, S303, and S304 in the third example, respectively.

S405

In S405, the positioning control unit 140 specifies a visible satellite signal at the center position of the specified grid based on the geospatial information, sets the center position of the specified grid as an initial coordinate value, and instructs the absolute position positioning unit 110 to perform a carrier-phase based positioning calculation using the specified visible satellite signal. The absolute position positioning unit 110 performs the carrier-phase based positioning calculation. In this way, by performing the carrier-phase based positioning calculation using the visible satellite signal, the positioning accuracy can be improved.

Further, in S405, when the number of visible satellite signals is equal to or larger than the predetermined threshold, the carrier-phase based positioning calculation may be performed using only the visible satellite signals, and when the number of visible satellite signals is less than the predetermined threshold, the carrier-phase based positioning calculation may be performed using both the visible satellite signals and the invisible satellite signals. The predetermined threshold is, for example, 5.

S406 to S408

The processes of S406, S407, and S408 in FIG. 6 are the same as the processes of S306, S307, and S308 described in the third example, respectively.

### Fifth Example

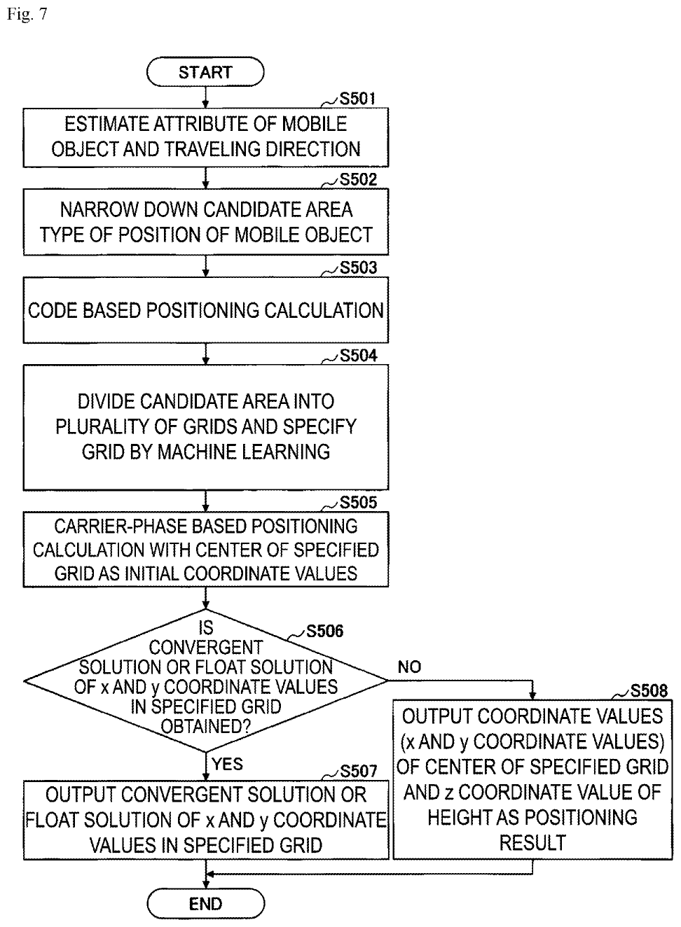

Hereinafter, a fifth example will be described with reference to a flowchart of FIG. 7. In the fifth example, differences from the first example will be mainly described.

S501 to S503

The processes of S501, S502, and S503 in FIG. 7 are the same as the processes of S101, S102, and S103 described in the first example, respectively.

S504

In S504, first, the positioning control unit 140 specifies the candidate area and divides the candidate area into a plurality of grids in the same manner as the process in S104 of the first example. In the fifth example, the following method is used as a method of specifying one grid in which the mobile object is estimated to be located in the candidate area.

The absolute position positioning unit 110 obtains observation data in positioning calculation of each received GNSS satellite signal. The observation data obtained here is observation data for all satellite signals received, including not only visible satellite signals but also non-visible satellite signals received as multipaths. The observation data is, for example, information on reception quality (for example, CNR) of each received GNSS satellite signal and information on a result of pseudo range and carrier-phase based positioning in positioning calculation of the GNSS receiver. The absolute position positioning unit 110 passes the measured observation data for each of the GNSS satellite signals to the positioning control unit 140.

The positioning control unit 140 holds a model (referred to as a “grid specification model” for convenience) learned by machine learning. The grid specification model may be stored in the data storage unit 150, and the positioning control unit 140 may read the grid specification model from the data storage unit 150 and use the grid specification model.

The positioning control unit 140 inputs the observation data for each GNSS satellite signal received from the absolute position positioning unit 110 to the grid specification model, and the grid specification model outputs one grid. The output grid is one grid in which the mobile object is estimated to be located in the candidate area, and is the “specified grid” described in the first to fourth examples. The grid specification model may be any model in machine learning, and is, for example, a neural network.

Regarding the learning of the grid specification model, for example, learning can be performed by using the observation data (for example, reception quality) of the GNSS satellite signal actually measured at various places (each of which has a correct answer grid) at an optional time and the correct answer grid as teacher data. That is, learning is performed by inputting observation data of the GNSS satellite signal to the grid specification model and adjusting parameters of the grid specification model so that a difference between a value (grid) output from the grid specification model and the correct answer grid becomes small. A crowdsourcing method can also be used to collect measured observation data of the GNSS satellite signal. For example, observation data of the GNSS satellite signal whose time and position have been specified can be collected from a smartphone terminal held by a passenger near a bus stop.

In addition, instead of using the observation data of the actual measurement value as described above as the teacher data, observation data (for example, reception quality) in various places (each of which has a correct answer grid) at an optional time may be generated using a GNSS signal simulator capable of simulating a pseudo signal including a multipath by three-dimensional ray trace simulation based on geospatial information, and learning may be performed using the observation data and the correct answer grid as learning data.

The processing of learning the grid specification model may be performed by the positioning control unit 140 of the position measuring apparatus 100 or may be performed by a device different from the position measuring apparatus 100, and the obtained grid specification model may be input to the positioning control unit 140 (or the data storage unit 150) of the position measuring apparatus 100.

S505

In S505, the positioning control unit 140 instructs the absolute position positioning unit 110 to perform a carrier-phase based positioning calculation with the center position of the specified grid as an initial coordinate value, and the absolute position positioning unit 110 performs a carrier-phase based positioning calculation using the initial coordinate value.

S506

In S506, the positioning control unit 140 determines whether a convergence (Fix) solution is obtained in the carrier-phase based positioning calculation using the center position of the specified grid as the initial coordinate value by the absolute position positioning unit 110, or whether a float solution of x and y coordinate values in the specified grid is obtained in the carrier-phase based positioning calculation.

The fact that the float solution of the x and y coordinate values in the specified grid is obtained means that the convergence (Fix) solution is not obtained by the carrier-phase based positioning calculation, but the float solution is obtained, and the two-dimensional position indicated by (x, y) in the three-dimensional coordinate values (x, y, z), which is the solution (position), is in the two-dimensional region of the specified grid.

When the determination result in S506 is Yes, the process proceeds to S507, and when the determination result in S506 is No, the process proceeds to S508.

S507: Case where determination result of S506 is Yes

The positioning control unit 140 transmits the convergence (Fix) solution or the float solution obtained by the absolute position positioning unit 110 to the output unit 130, and the output unit 130 outputs the convergence (Fix) solution or the float solution.

S508: Case where determination result of S506 is No

The positioning control unit 140 transmits the x and y coordinate values of the center position of the specified grid and the z coordinate value that is height information (the height of the road surface, the value obtained by adding the height of the reception position of the mobile object to the height of the road surface, and the like) of the center position of the specified grid obtained from the geospatial information to the output unit 130 as a positioning result, and the output unit 130 outputs the positioning result.

### Sixth Example

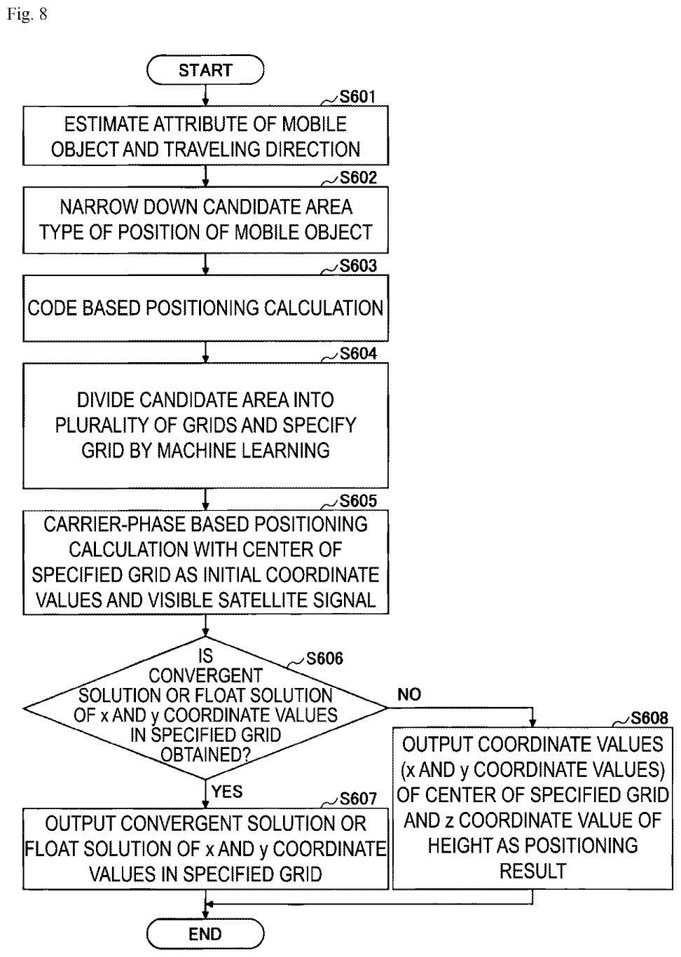

Next, a sixth example will be described with reference to a flowchart of FIG. 8. In the sixth example, differences from the fifth example will be mainly described.

S601 to S604

The processes of S601, S602, S603, and S604 in FIG. 8 are the same as the processes of S501, S502, S503, and S504 in the fifth example, respectively.

S605

In S605, the positioning control unit 140 specifies a visible satellite signal at the center position of the specified grid based on the geospatial information, sets the center position of the specified grid as an initial coordinate value, and instructs the absolute position positioning unit 110 to perform a carrier-phase based positioning calculation using the specified visible satellite signal. The absolute position positioning unit 110 performs the carrier-phase based positioning calculation. In this way, by performing the carrier-phase based positioning calculation using the visible satellite signal, the positioning accuracy can be improved.

Further, in S605, when the number of visible satellite signals is equal to or larger than the predetermined threshold, the carrier-phase based positioning calculation may be performed using only the visible satellite signals, and when the number of visible satellite signals is less than the predetermined threshold, the carrier-phase based positioning calculation may be performed using both the visible satellite signals and the invisible satellite signals. The predetermined threshold is, for example, 5.

S606 to S608

The processes of S606, S607, and S608 in FIG. 8 are the same as the processes of S506, S507, and S508 in the fifth example, respectively.

In the second to sixth example, when the convergence (Fix) solution is not obtained in the carrier-phase based positioning calculation and the float solution of the x and y coordinate values in the specified grid is obtained, the float solution is output. However, when the convergence (Fix) solution is not obtained in the carrier-phase based positioning calculation and the float solution of the x and y coordinate values in the candidate area is obtained, the float solution may be output.

In addition, also in S105 of the first example and S205 of the second example, similarly to S405 of the fourth example and S605 of the second example, the positioning control unit 140 may specify a visible satellite signal at the center position of the specified grid based on the geospatial information, set the center position of the specified grid as an initial coordinate value, and instruct the absolute position positioning unit 110 to perform a carrier-phase based positioning calculation using the specified visible satellite signal. The absolute position positioning unit 110 performs the carrier-phase based positioning calculation.

### Modified Example

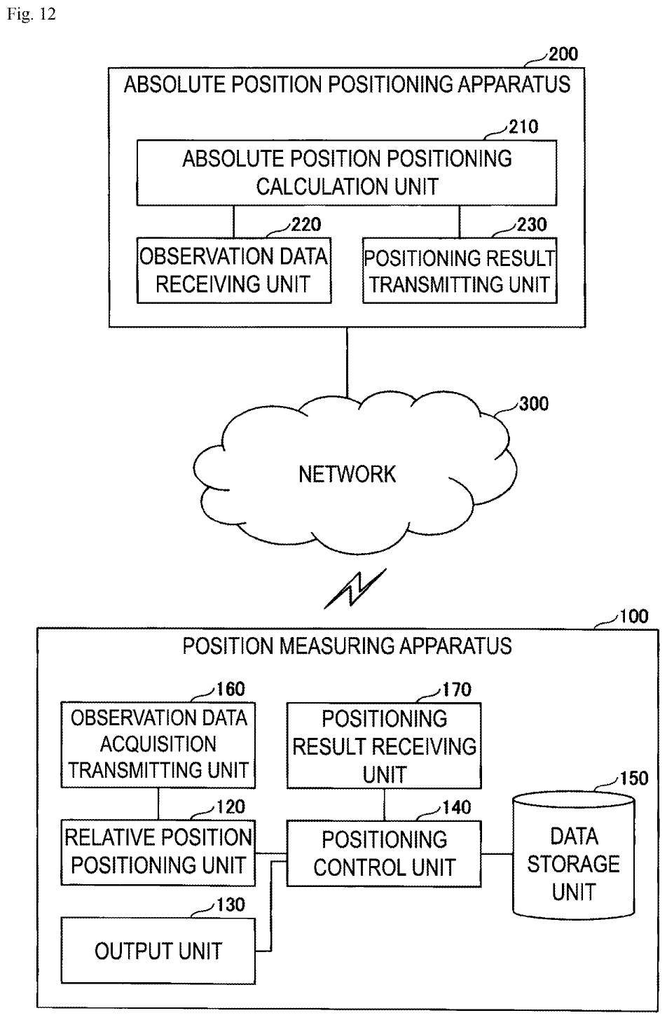

As described above, the position measuring apparatus 100 may be one physically integrated device, or may be a device in which some functional units are physically separated and a plurality of separated functional units are connected by a network. For example, the carrier-phase based positioning calculation may be performed by a device via a network, for example, a device on a cloud. FIG. 12 illustrates a system configuration example in that case.

An absolute position positioning apparatus 200 is provided on a network 300. This absolute position positioning apparatus 200 is a device on a cloud.

The absolute position positioning apparatus 200 includes an absolute position positioning calculation unit 210, an observation data receiving unit 220, and a positioning result transmitting unit 230. The observation data receiving unit 220 receives observation data obtained by observing a GNSS satellite signal by a mobile object (position measuring apparatus 100). The absolute position positioning calculation unit 210 executes a carrier-phase based positioning calculation using the observation data. The positioning result transmitting unit 230 transmits the obtained positioning result to the position measuring apparatus 100.

As compared with the configuration of FIG. 1, the position measuring apparatus 100 illustrated in FIG. 12 does not include the absolute position positioning unit 110, but includes an observation data acquisition transmitting unit 160 and a positioning result receiving unit 170. The observation data acquisition transmitting unit 160 receives and observes the GNSS satellite signal, and transmits the observation data to the absolute position positioning apparatus 200. The positioning result receiving unit 170 receives a positioning result from the absolute position positioning apparatus 200 and passes the positioning result to the positioning control unit 140.

The processing contents other than the processing related to the absolute position positioning are the same as the processing contents described above. Information exchange between the positioning control unit 140 and the absolute position positioning unit 110 described above is information exchange between the positioning control unit 140 and the absolute position positioning apparatus 200 via the network 300 in the configuration of FIG. 12.

Furthermore, as described above, the positioning control unit 140 may be provided on the cloud. For example, in the configuration of FIG. 12, the positioning control unit 140 may be provided in the absolute position positioning apparatus 200 instead of the position measuring apparatus 100, or means for performing the absolute position positioning calculation may be left in the position measuring apparatus 100, and only the positioning control unit 140 may be provided on the cloud.

### Effects of Embodiments

As described above, according to the present embodiment, the candidate area type of the position is specified based on the attribute of the mobile object, the grid in the candidate area corresponding to the candidate area type is narrowed down based on the geospatial information, and the positioning calculation based on the result is executed, so that the positioning accuracy in the urban canyon reception environment can be improved. In the carrier-phase based positioning method, the closer the initial coordinate value is to the true value, and the more the visible satellite signals are used, the more the possibility of obtaining a convergence (Fix) solution is improved. However, according to the present embodiment, by using the geospatial information in combination, it can be expected that the effects of both can be enhanced as compared with the case of positioning using only the GNSS satellite signals.

### Conclusion of Embodiments

### Item 1

A position measuring apparatus for positioning a mobile object, including

a positioning control unit that

determines a candidate area type of a position of the mobile object in accordance with an attribute of the mobile object and geospatial information,

divides a candidate area corresponding to the candidate area type into a plurality of grids and specifies a grid in which the mobile object is estimated to be located from among the plurality of grids, and

outputs a positioning solution of a carrier-phase based positioning calculation by an absolute position positioning unit, the positioning solution being obtained by using the grid specified.

### Item 2

The position measuring apparatus according to item 1, wherein

the positioning control unit compares data of a structure around the mobile object with geospatial information to specify the grid in which the mobile object is estimated to be located from among the plurality of grids.

### Item 3

The position measuring apparatus according to item 1, wherein

the positioning control unit uses a grid specification model learned by machine learning to specify the grid in which the mobile object is estimated to be located from among the plurality of grids in accordance with observation data of a GNSS satellite signal received by the mobile object.

### Item 4

The position measuring apparatus according to any one of items 1 to 3, wherein

the absolute position positioning unit performs a carrier-phase based positioning calculation using, as an initial coordinate value, a center position of the grid specified,

when, as a positioning solution of the carrier-phase based positioning calculation, a convergent solution or a float solution having two-dimensional coordinate values in the grid specified is obtained, the positioning control unit outputs the convergent solution or the float solution, and

when, as a positioning solution of the carrier-phase based positioning calculation, neither the convergent solution nor the float solution is obtained, the positioning control unit outputs, as a positioning result, two-dimensional coordinate values of the center position of the grid specified and a coordinate value indicating a height of the center position.

### Item 5

The position measuring apparatus according to any one of items 1 to 3, wherein

the absolute position positioning unit performs a carrier-phase based positioning calculation using, as an initial coordinate value, a center position of the grid specified,

when, as the positioning solution of the carrier-phase based positioning calculation, a convergent solution or a float solution having two-dimensional coordinate values in the candidate area is obtained, the positioning control unit outputs the convergent solution or the float solution, and

when, as a positioning solution of the carrier-phase based positioning calculation, neither the convergent solution nor the float solution is obtained, the positioning control unit outputs, as a positioning result, two-dimensional coordinate values of the center position of the grid specified and a coordinate value indicating a height of the center position.

### Item 6

The position measuring apparatus according to any one of items 1 to 3, wherein

the absolute position positioning unit uses, as initial coordinate values, a center position of the grid specified and performs a carrier-phase based positioning calculation using a visible satellite signal at the center position,

when, as the positioning solution of the carrier-phase based positioning calculation, a convergent solution or a float solution having two-dimensional coordinate values in the grid specified is obtained, the positioning control unit outputs the convergent solution or the float solution, and

when, as the positioning solution of the carrier-phase based positioning calculation, neither the convergent solution nor the float solution is obtained, the positioning control unit outputs, as a positioning result, two-dimensional coordinate values of the center position of the grid specified and a coordinate value indicating a height of the center position.

### Item 7

A positioning method executed by a position measuring apparatus for positioning a mobile object, the positioning method including:

determining a candidate area type of a position of the mobile object in accordance with an attribute of the mobile object and geospatial information;

dividing a candidate area corresponding to the candidate area type into a plurality of grids, and specifying a grid in which the mobile object is estimated to be located from among the plurality of grids; and

outputting a positioning solution of a carrier-phase based positioning calculation by an absolute position positioning unit, the positioning solution being obtained by using the grid specified.

### Item 8

A program causing a computer to operate as the positioning control unit in the position measuring apparatus according to any one of items 1 to 6.

Although the present embodiment has been described above, the present disclosure is not limited to such specific embodiments, and can be modified and changed variously without departing from the scope of the present disclosure described in the appended claims.

### REFERENCE SIGNS LIST

100 Position measuring apparatus
110 Absolute position positioning unit
120 Relative position positioning unit
130 Output unit
140 Positioning control unit
150 Data storage unit
160 Observation data acquisition transmitting unit
170 Positioning result receiving unit
200 Absolute position positioning apparatus
210 Absolute position positioning calculation unit
220 Observation data receiving unit
230 Positioning result transmitting unit
300 Network
1000 Drive device
1001 Recording medium
1002 Auxiliary storage device
1003 Memory device
1004 CPU
1005 Interface device
1006 Display device
1007 Input device
1008 Output device

1. A position measuring apparatus for positioning a mobile object, the position measuring apparatus comprising:
a processor; and
a memory that includes instructions, which when executed, cause the processor to execute the following steps:
determining a candidate area type of a position of the mobile object in accordance with an attribute of the mobile object and geospatial information,
dividing a candidate area corresponding to the candidate area type into a plurality of grids and specifying a grid in which the mobile object is estimated to be located from among the plurality of grids, and
outputting a positioning solution of a carrier-phase based positioning calculation, the positioning solution being obtained by using the grid specified.

2. The position measuring apparatus according to claim 1, wherein
the steps executed by the processor further includes comparing data of a structure around the mobile object with geospatial information to specify the grid in which the mobile object is estimated to be located from among the plurality of grids.

3. The position measuring apparatus according to claim 1, wherein
the steps executed by the processor further includes using a grid specification model learned by machine learning to specify the grid in which the mobile object is estimated to be located from among the plurality of grids in accordance with observation data of a GNSS satellite signal received by the mobile object.

4. The position measuring apparatus according to claim 1, wherein
the carrier-phase based positioning calculation is performed by using, as initial coordinate values, a center position of the grid specified,
when, as the positioning solution of the carrier-phase based positioning calculation, a convergent solution or a float solution having two-dimensional coordinate values in the grid specified is obtained, the steps executed by the processor further includes outputting the convergent solution or the float solution, and
when, as the positioning solution of the carrier-phase based positioning calculation, neither the convergent solution nor the float solution is obtained, the steps executed by the processor further includes outputting, as a positioning result, two-dimensional coordinate values of the center position of the grid specified and a coordinate value indicating a height of the center position.

5. The position measuring apparatus according to claim 1, wherein
the carrier-phase based positioning calculation is performed by using, as initial coordinate values, a center position of the grid specified,
when, as the positioning solution of the carrier-phase based positioning calculation, a convergent solution or a float solution having two-dimensional coordinate values in the candidate area is obtained, the steps executed by the processor further includes outputting the convergent solution or the float solution, and
when, as the positioning solution of the carrier-phase based positioning calculation, neither the convergent solution nor the float solution is obtained, the steps executed by the processor further includes outputting, as a positioning result, two-dimensional coordinate values of the center position of the grid specified and a coordinate value indicating a height of the center position.

6. The position measuring apparatus according to claim 1, wherein
the carrier-phase based positioning calculation uses, as initial coordinate values, a center position of the grid specified and the carrier-phase based positioning calculation uses a visible satellite signal at the center position,
when, as the positioning solution of the carrier-phase based positioning calculation, a convergent solution or a float solution having two-dimensional coordinate values in the grid specified is obtained, the steps executed by the processor further includes outputting the convergent solution or the float solution, and
when, as the positioning solution of the carrier-phase based positioning calculation, neither the convergent solution nor the float solution is obtained, the steps executed by the processor further includes outputting, as a positioning result, two-dimensional coordinate values of the center position of the grid specified and a coordinate value indicating a height of the center position.

7. A positioning method executed by a position measuring apparatus for positioning a mobile object, the positioning method comprising:
determining a candidate area type of a position of the mobile object in accordance with an attribute of the mobile object and geospatial information;
dividing a candidate area corresponding to the candidate area type into a plurality of grids and specifying a grid in which the mobile object is estimated to be located from among the plurality of grids; and
outputting a positioning solution of a carrier-phase based positioning calculation, the positioning solution being obtained by using the grid specified.

8. A non-transitory computer readable storage medium storing a program, which when executed, cause a computer to execute the following steps:
determining a candidate area type of a position of the mobile object in accordance with an attribute of the mobile object and geospatial information,
dividing a candidate area corresponding to the candidate area type into a plurality of grids and specifying a grid in which the mobile object is estimated to be located from among the plurality of grids, and
outputting a positioning solution of a carrier-phase based positioning calculation, the positioning solution being obtained by using the grid specified.
